(19) United States
(12) Patent Application Publication
(10) Pub. No.: US 2006/0015943 A1
(43) Pub. Date: Jan. 19, 2006

(54) Method and device for analyzing an information sytem security

(76) Inventor: Michel Mahieu, Vauhallan (FR)

Correspondence Address: MCCRACKEN & FRANK LLP, 200 W. ADAMS STREET, SUITE 2150, CHICAGO, IL, 60606, US

(21) Appl. No.: 10/534,855

(22) PCT Filed: Nov. 5, 2003
(86) PCT No.: PCT/FR03/03309

§ 371 Date: May 13, 2005

(30) Foreign Application Priority Data
Nov. 14, 2002 (FR) 02/14279

(51) Int. Cl. G06F 11/00

(52) U.S. Cl. 726/25

(57) ABSTRACT

There is proposed a method for analyzing the security of an information system comprising a modeling phase, including modeling of the information system, and a simulating phase, including specification and simulation of potential attack against the information system.

The present invention pertains to the field of tools for analyzing and controlling information systems security (ISS).

Structured-design tools (such as SADT or SART) of an information system take no account of the security of the system. Generalist risk analysis procedures (such as Marion, Melisa or CRAMM) are imprecise, and incapable of revealing the technical flaws of a system. Operational dependability tools (SDF) are limited to the problems of reliability and availability, but take no account of malice. Intrusion detection systems (IDS) and vulnerability analyzers operate only on real systems, are specific to a restricted domain, and have only a partial picture of security. Security strategy editors operate from the viewpoint of the defender only, and comprise no function for analyzing the consistency of security, nor for searching for possible flaws and attacks.

The invention is directed at a method and a device for analyzing the security of information systems which relies on the modeling and simulation of the system and of possible attacks, so as to analyze and control the security of the system.

More particularly, a first aspect of the invention relates to a method for analyzing the security of an information system comprising:
a modeling phase, comprising the modeling of the information system, and
a simulation phase, comprising the specification and the simulation of potential attacks against the information system.

The modeling phase comprises the specification of the architecture of the system with a set of components of the system and relations between said components, that is to say according to a components/relations model.

Preferably, determined states are associated with each component of the information system, each state being able to take a sound value and one or more unsound values. Certain at least of said states pertain respectively to the activity, the confidentiality, the integrity and/or the availability of the component with which they are associated.

Preferably, the modeling phase further comprises the specification of a set of behavioral rules, in particular from the system operation standpoint and from the security standpoint (protection rules), associated with the components of the system.

According to an advantage of the invention, the user can adopt the viewpoint of the defender during the modeling phase, and the viewpoint of the attacker during the simulation phase. By iterating alternate modeling phases and simulation phases, he succeeds in controlling the security of the information system.

According to another advantage, the invention makes it possible to analyze the security of an information system without intervening directly on the latter. Specifically, the launching of the attacks is effected on a virtual system, corresponding to the real system modeled.

Advantageously, the analysis of the security may take place very early in the information system design process, and in particular before its physical deployment.

The method makes it possible to model an information system, while restricting oneself to its security aspects, and hence while remaining controllable by a human person, by virtue of simplifying concepts and principles. The invention makes it possible to handle in a generic manner in particular the technical aspects (that is to say those related to the technical characteristics of the information system), human, procedural and physical aspects (for example geographical aspects). A good compromise between realism and simplicity of modeling allows a user (typically the designer or the administrator of the information system, or a security technical auditor) to model the information system without having to reproduce it completely.

The method also makes it possible to realistically simulate all attacks known within the world of information systems. These attacks turn out to be generic, and may apply to fields connected with information systems (physical security for example).

Finally, it makes it possible to realistically simulate all the parries known within the world of information systems, be they for prevention or for detection. The modeling of prevention parries is carried out by security rules. The modeling of detection parries is carried out by means of metrics.

To summarize, the method makes it possible to quickly analyze the feasibility of a very large number of attacks on a given system. With little experience, the user can simulate around 100 to 200 elementary attacks per day, this being considerably more than what could be done on a real system.

A second aspect of the invention relates to a device for the implementation of a method according to the first aspect. For this purpose, the device advantageously comprises a man/machine interface for the implementation of the modeling phase and/or an attacks/parries engine for the implementation of the simulation phase.

Advantageously, the man/machine interface exhibits a functionality of multiview display of the system modeled.

Preferably, the man/machine interface makes it possible to display the system modeled according to a components/relations model.

The device is intended to be used as a technical audit tool for the security of existing information systems (that is to say those already deployed), for which it has the advantage of not disturbing them during their utilization. It may in particular analyze destructive attacks without affecting the real system.

The device can also be used as a tool for aiding the design of the security of systems currently under design or production, thereby making it possible to tailor and test their protection policy even before their installation.

It may also be used as a favored tool for system certification, in the sense of security certification according to the existing standardization: TCSEC, ITSEC (“Information Technology Security Evaluation Criteria”) and CC (“Common Criteria”). This standardization in fact currently makes it possible to certify products with sharply delimited contours, but has hitherto been inapplicable to systems. The latter are in fact too vast, complex, heterogeneous, have contours that are poorly defined and changeable, to be evaluated with the techniques for evaluating products.

To summarize, the device is a tool intended for security specialists: system administrators, security technical auditors. To such people it affords in addition the possibility of adopting the viewpoint of the attacker, which viewpoint is absolutely necessary for constructing effective and suitable protection.

Other characteristics and advantages of the invention will become further apparent on reading the description which follows. The latter is purely illustrative and should be read in conjunction with the appended drawings in which:

FIG. 1 is a chart illustrating the modeling and simulation phases according to the method of the invention;

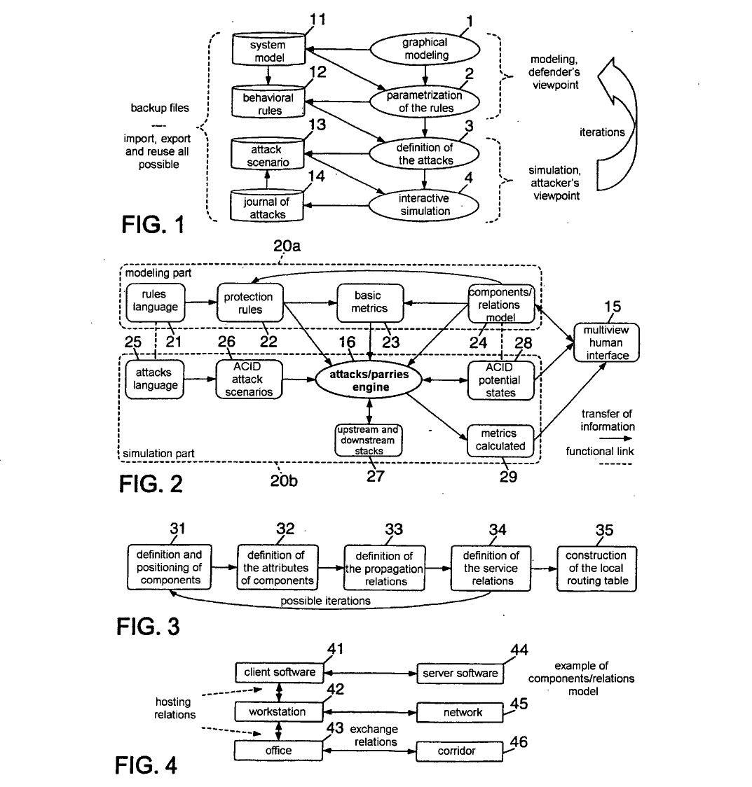

FIG. 2 is a schematic diagram illustrating the elements of a device according to the invention;

FIG. 3 is a diagram illustrating the construction of a components/relations model for an information system;

FIG. 4 is a diagram showing an exemplary components/relations model, in which appear relations of hosting and relations of exchange between components;

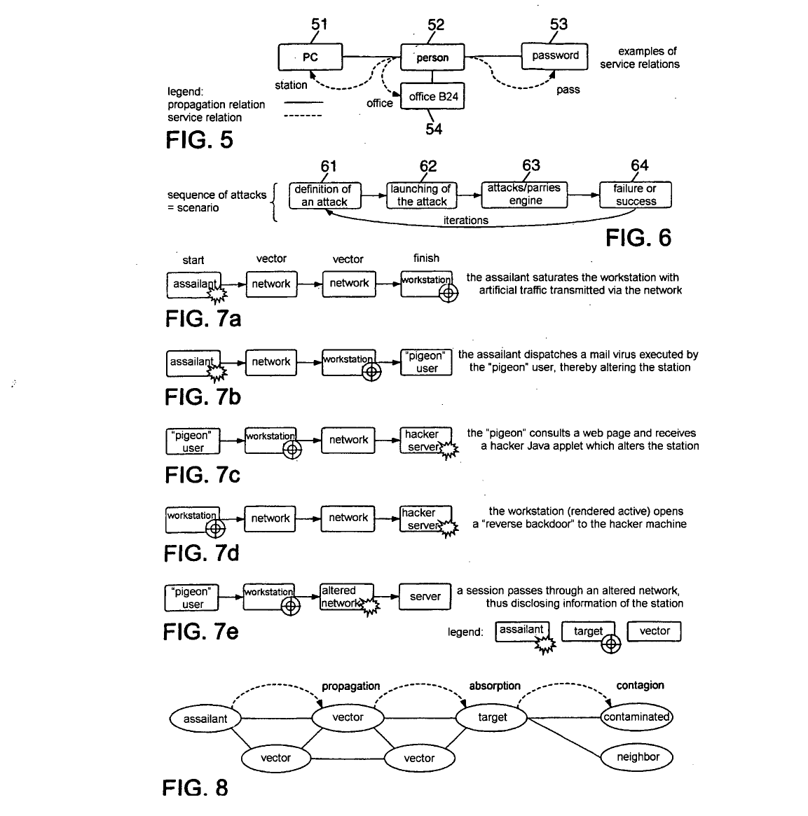

FIG. 5 is a diagram illustrating examples of service relations between components of an information system modeled according to the invention;

FIG. 6 is a diagram which illustrates a detailed example of the simulation phase of the method according to the invention;

FIGS. 7a to 7e are diagrams which illustrate examples of attack paths;

FIG. 8 is a diagram showing the transmission of an attack through an attack path in a modeled information system;

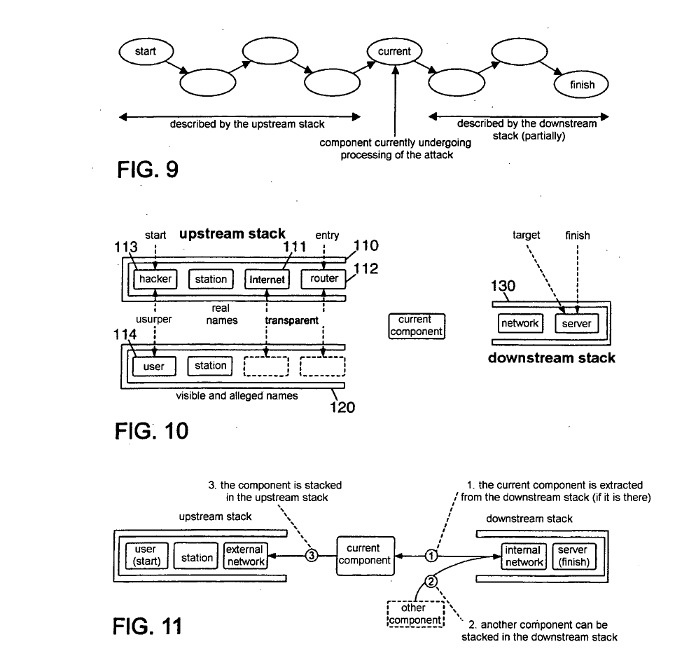

FIG. 9 and FIG. 10 are diagrams presenting a mechanism of upstream and downstream stacks;

FIG. 11 is a diagram illustrating an example of the operation of the upstream and downstream stacks;

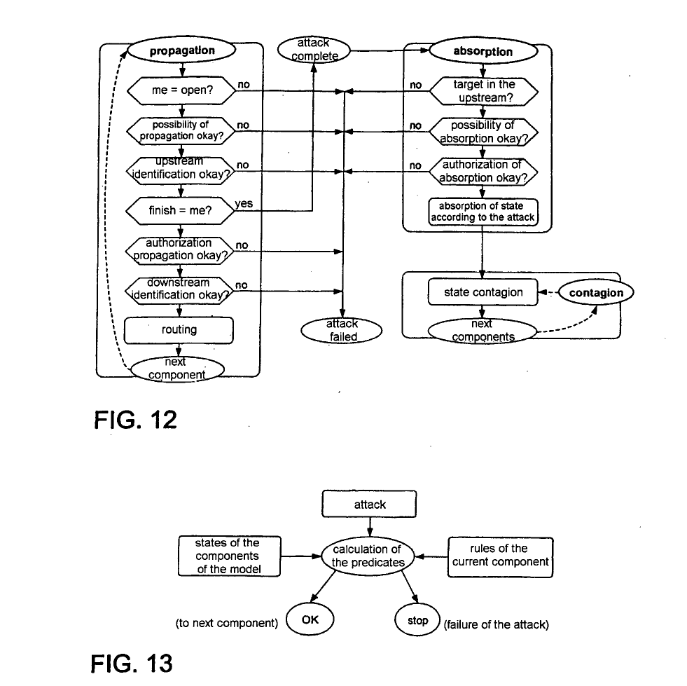

FIG. 12 is a chart illustrating the general operating algorithm of the attacks/parries engine;

FIG. 13 is a chart which illustrates a mechanism for applying protection rules;

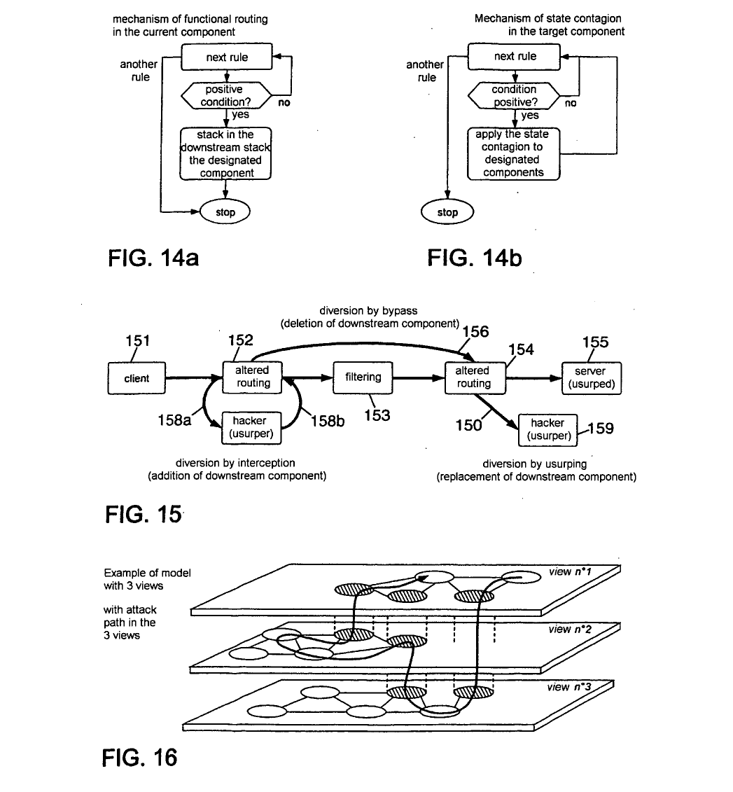

FIGS. 14a and 14b are charts illustrating a functional routing mechanism and a states contagion mechanism, respectively;

FIG. 15 is a diagram illustrating diversion techniques in a modeled information system;

FIG. 16 is a diagram illustrating the displaying of a modeled system, with a multiview functionality;

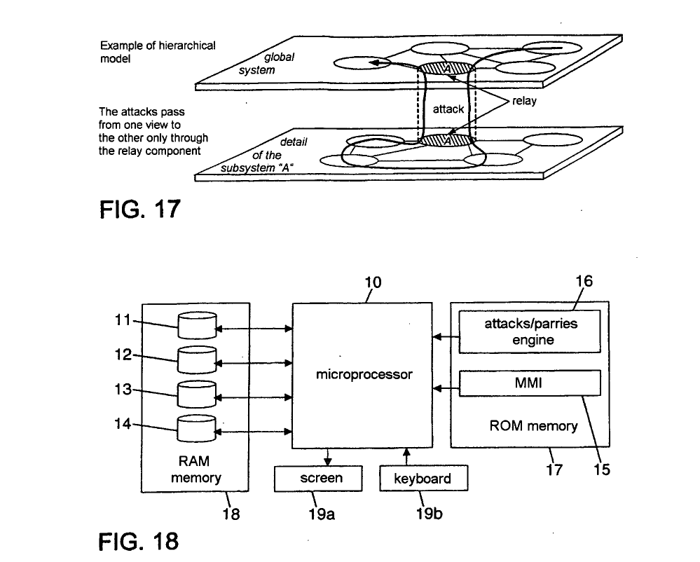

FIG. 17 is a diagram illustrating the multiview display according to a hierarchical approach; and

FIG. 18 is a schematic diagram of a device according to the invention.

As illustrated by the graph of FIG. 1, the method comprises two usage phases, themselves decomposed into two steps.

During a modeling phase, the user adopts the viewpoint of the defender. The modeling phase comprises a step 1 of specifying the architecture of the system with a set of components of the system and relations between said components, which comprise propagation relations and service relations. Step 1 culminates in a modeled architecture, hereinafter called the components/relations model, of the real system, this model being saved in the form of a file in a memory 11. This model may be represented graphically by a graph comprising boxes symbolizing the components, connected by arrows symbolizing the relations. The modeling phase also comprises a step 2 of specifying behavioral rules, not to be confused with the aforesaid relations. These behavioral rules define the manner of operation of each component, from the operational and security standpoints, in particular the protections that it provides. Step 2 culminates in the construction of a file of behavioral rules, which is saved in a memory 12.

Conversely, during a simulation phase, the user adopts the viewpoint of the attacker. The simulation phase comprises a step 3 of specifying the attacks, which culminates in the creation of one or more attack scenarios. These scenarios are saved in the form of files in a memory 13. The simulation phase also comprises a step 4 of interactive simulation of attacks. This simulation is carried out by an attacks/parries engine. It culminates in the creation of a journal of the attacks, which is saved in the form of a file in a memory 14.

The files saved in the memories 11, 12, 13 and 14 may be imported from or exported to various applications, so that their reuse is possible.

The modeling phase 10 and simulation phase 20 may be alternately iterated, each time modifying all or part of the parameters (components/relations model, behavioral rules, attacks) taken into account. This allows good control of the security of the system by the user.

In the subsequent description, there is described a mode of implementation of steps 1 to 4 of the method, with however a modified presentation as to the order of the steps. Specifically, step 3 (specification of attacks) and step 4 (interactive simulation by attacks/parries engine) are set out before step 2 (parametrization of the protection rules), so as to aid the comprehension of the text. Furthermore, the description of these steps is supplemented with a presentation of two complementary mechanisms: the metrics and the man/machine interface (MMI).

Firstly, the main elements of a device according to the invention are presented with reference to the functional chart of FIG. 2. In this figure are represented at the top a group 20a of the elements used during the modeling phase, and at the bottom a group 20b of those used during the simulation phase. Moreover, a man/machine interface 15 is represented on the right.

The group 20a comprises a language of rules 21 making it possible to formulate the protection rules 22, a set of basic metrics 23, and the components/relations model 24.

The group 20b comprises a language of attacks 25 making it possible to formulate the attack scenarios 26, the attacks/parries engine 16, an upstream and downstream stacks mechanism 27, a set of potential states 28 and calculated metrics 29.

In FIG. 2, the solid line arrows symbolize the transfers of information between the elements, and the broken lines symbolize the functional links between the elements. The role of each of these elements will become apparent in what follows.

The first step of the method, step 1, consists in constructing the components/relations model (or architecture) of the real system via the human interface 15. To do this, the system is decomposed into elementary components (or atoms), endowed with attributes, and connected by relations.

The steps of the construction of the components/relations model are illustrated by the graph of FIG. 3.

A first step 31, the user puts into place on a two-dimensional graph the components which form the system. In an example, each component is represented by a rectangle containing its four potential states and its name.

The components may represent all kinds of heterogeneous real objects of physical type (site, building, storey, premises, strongrooms, door, window, lock, key, etc.), a medium (paper, fixed disk, diskette, CD Rom, magnetic tape, etc.), a network (electrical, computing, telephonic, RF, aerial, etc.), hardware (mechanical, network, computing, station, server, screen, keyboard, printer, etc.), software (OS, driver, application, service, etc.), data (directory, file, information, database, password, etc.), people (user, assailant, director, administrator, organization, service, etc.), and so on. This indicative list is nonlimiting.

Each component has several attributes, which are defined in a step 32. The attributes comprise static attributes and dynamic attributes. The static attributes comprise for example a name (composed of a nature and of an identifier), and possibly one or more adjectives. The dynamic attributes comprise for example potential states referred to as “ACID” states (see later), an alleged name (in the case where the component is a usurper), and a link to a usurper component (in the case where the component is usurped).

The adjectives are intended to make it possible to designate components without naming them, and to do so either in rules (for example: access is denied to all the “external” components), or in attacks (for example: discover all the “IP” components). The list of adjectives is open, and defined by the user during modeling. An example of adjectives classed by utility is given by table I hereinbelow:

TABLE I

| Utility | Adjectives |
|---|---|
| Membership | Internal, external, private, |
| | public, establishment, group, |
| | central, local, remote |
| Sensitivity, gravity | Normal, important, critical, |
| | vital, rights reserved (DR), |
| | confidential defense (CD), secret |
| | defense (SD), top secret defense |
| | (TSD), tactical, strategic |
| Access entitlement, | User, author, reader, editor, |
| technical or | technician, operator, utilizer, |
| organizational role, | administrator, trainee, employee, |
| internal or external | guard, supervisor, manager, boss, |
| | director, client, partner, |
| | consultant, supplier, client, |
| | competitor |
| Trusted or untrusted | Reliable, loyal, sincere, |
| | serious, known, unknown, dubious, |
| | suspect, hacker |
| Technique | IP, network, computing, OS, |
| | executable, information, fixed, |
| | mobile |
| Protection | Encrypted, hidden, backed-up, |
| | catalogued, administered, |
| | duplicated |

Modeling is a complex task for the user. This is why the modeling mechanisms are designed to operate even on a model that is not fully completed, hence may possibly be partially inconsistent. This allows the user to work according to a progressive and iterative process, alternating the modeling and the tests of operation by simulation.

The components are ubiquitous and timeless. The aim of this principle is to simplify the modeling work, without being detrimental to realism, insofar as the topic is security. It is manifested concretely by the fact that a component may be, in particular:
multiple, that is to say represent several similar real objects situated at several places;
dispersed, that is to say represent an object of large size not situated in a precise zone (for example a network);
partial, that is to say represent a part of a complex real object;
replicated, when two components can represent the same real object (for convenience of modeling);
duplicated, when, for example, a first real file exhibits several copies on several media;
temporary, that is to say represent for example an intermittent telephonic communication; and
mobile: for example, a portable station, or a person are mobile (“nomadic”) by nature.

Propagation relations associated with the components are defined in a step 33. These relations are bidirectional, and able to convey attacks in both directions. They may be of two distinct types: of hosting type (capacity, supply) and of exchange type.

The diagram of FIG. 4 illustrates an example of hosting relations (symbolized by vertical arrows) between a client software 41, a workstation 42 (a personal computer or PC) in which said client software is saved, and an office 43 in which said workstation is situated. The same diagram also illustrates exchange relations between the client software 41 and a server software 44 with which the client software exchanges data, between the workstation 42 and a computing network to which the workstation is linked 45, and between the office 43 and a corridor 46 allowing access to said office.

When a component is traversed by an attack, it may or may not leave a trace of the passage in the attack. For example, a postal package bears the postmark of the issuing post office, but not of the receiving post office. Likewise, an IP (“Internet Protocol”) packet contains or otherwise the IP address of a router traversed.

To take account of this reality, each component, for each of the relations which it receives, has an indicator of transparency or opacity. If it is transparent, it will not be seen from the components downstream in the path of the attack, and these components will not therefore be able to take account thereof in their protection rules. If conversely it is opaque, the downstream components will see it, but it will hide the upstream components of the same type (that is to say having the same adjectives).

Alongside the propagation relations, provision is also made for service relations, which are defined in a step 34. The service relations are unidirectional, and do not convey attacks. Their aim is to make it possible to designate a component on the basis of another, in the form of an indexation.

The diagram of FIG. 5 illustrates an exemplary service relation. In this figure are represented a workstation 51, a person 52, a password 53 and an office 54. Propagation relations between these components are symbolized by continuous lines, and service relations are symbolized by discontinuous lines of which it is composed. In this example, the component “password” 53 may be designated by the formula “pass(person)”. Likewise, the component “office B24” may be designated by “office(person)”.

Returning to FIG. 3, it will be noted that steps 31 to 34 may be iterated so as to allow the user to refine the construction of the components/relations model.

When the components/relations model is completed, a routing table is constructed in a step 35. This table is calculated automatically according to the principle of the shortest path between the components, using the propagation relations alone. The result is for example a start component/finish component matrix.

The temporal profile of each component is stored by means of four potential states, called “ACID” states (A=activity, C=confidentiality, I=integrity, D=availability). These states correspond to the three known domains of security (C, I, D), to which has been added the state “A” for “activity”. The latter state represents the ability of a component to act, either in a normal manner (licit), or in a malicious manner, this being under the influence of the assailant.

It will be noted that these states ACID correspond substantially to the elementary rights of the security models: “XRWD” (X=execute, R=read, W=write, D=delete). They are independent of one another.

In an example each state has four possible values: normal, weakened, degraded, dangerous. In an example, these values are coded on the components/relations graph by a color code (for example green, yellow, red, dark blue, respectively), used for filling in the rectangle symbolizing each component.

Table II hereinbelow gives the meaning of the four possible values of the four potential ACID states.

TABLE II

| ACID | | | | |
|---|---|---|---|---|
| states: | Activity | Confidentiality | Integrity | Availability |
| Sound | closed | discreet | intact | available |
| Weakened | open | discovered | usurper | saturated |
| Degraded | active | divulged | altered | blocked |
| Dangerous | interactive | betrayed | corrupted | destroyed |

The aim of the analysis is to study the possibility of effecting an intrusion into a system. Insofar as it is necessary to make simplifications with respect to reality, it is preferable to simplify in the direction of pessimism, doing so with the aim of security. Stated otherwise, the device may see intrusions where there are none, but must not forget intrusions that are actually possible. The user will then take things in his stride, if necessary.

This principle, the so-called “worst case policy” is applied in the attacks/parries engine in the following manner.

At the start of the modeling, the four potential states of each component are respectively initialized to the value “sound”. The user can initialize them manually to a different value if he so wishes. The states may then evolve only toward degradation, as and when the attacks succeed.

The states are “potential”, that is to say they signify that the components “may” be in the states indicated, but not necessarily. This implies that two apparently incompatible states (for example, a component which is both “active” and “destroyed”) can coexist. When two states are incompatible or inconsistent, the device chooses the situation which is most unfavorable to the defender.

When a (modeled) component represents several real objects, its potential states are those of the most degraded real object.

Finally, the test of a state of a component in a rule does not correspond to a relation of equality, but to an order relation. For example, the test “component=blocked” is positive if the component is either “blocked”, or “destroyed”.

An exemplary implementation of step 3 and of step 4 of the method, namely the specification of the attack scenarios and their interactive simulation, will now be described. For this purpose, reference is made to the chart of FIG. 6.

In a step 61, an attack is defined. In an example, an attack is envisaged for each degradation of an ACID state. The corresponding attacks are called elementary attacks hereinafter. They are linked directly to the ACID states. For example, to cause a component to pass to the “blocked” state, the “block” attack is used.

There are therefore twelve elementary attacks (corresponding to the twelve unsound values of potential states), which are summarized in table III hereinbelow, plus a special attack referred to as a usurping attack. The latter attack, called “ChangeNameAlleged”, allows a component to usurp the name of another. Usurping is in fact a fundamental technique of intrusion.

TABLE III

| ACID | | | | |
|---|---|---|---|---|
| attacks | Activity | Confidentiality | Integrity | Availability |
| weak | open | discover | usurp | saturate |
| serious | activate | spy | alter | block |
| dangerous | penetrate | betray | corrupt | destroy |

When defining an elementary attack, the user (who takes up the standpoint of the attacker) enters the following parameters:
type of attack, out of the 13 hereinabove;
type of protocol (see hereinbelow); and,
elements of the path (see later).

The “protocol” generalizes the concept of telecommunication protocol, and designates any means of transmitting an attack between two components. An attack is always made concrete by the transmission in the system of a real, physical or logical, object conveying malicious information, software or mechanisms.

The list of protocols is open, the user being able to define as many of them as he wishes during modeling. Examples of protocols are:
physical protocols: letter, parcel, diskette, CD Rom, person, etc.
logic and computing protocols: mail, web, file, Telnet, Netbios, TCP/IP, FTP, SSL, etc.
specialized protocols: missile, RF wave, laser, etc.
etc.

The attack language uses the same words as the rules language, and makes it possible to define complex attack scenarios. An elementary attack line is for example:
“start=assailant+intermediate=Internet+protocol=mail+finish=user+attack=destroy+target=station (user)”

In English, this attack line signifies that the assailant is dispatching, via the Internet, an email to the user, containing a logic bomb which will destroy his station.

The attack path is one of the central concepts of the device, the object of which is precisely to find attack paths in a modeled system. During simulation, the user specifies the path in the following form:
a start component;
a finish component;
a target component; and, possibly
an intermediate component.

The assailant and the target must necessarily be on the path, but not necessarily at the beginning or at the end. The diagram of FIGS. 7a to 7e show various possibilities (nonlimiting) of the attack path, which may each correspond to a real case. For example, when the target is a workstation:
in FIG. 7a, the assailant saturates the workstation with artificial traffic transmitted via the network;
in FIG. 7b, the assailant dispatches a virus by email which is executed by a “pigeon” user, thereby altering the workstation;
in FIG. 7c, the assailant is a hacker server, and it is a “pigeon” user that consults a web page on a hacker server and receives a hacker Java applet which alters the station;
in FIG. 7d, the assailant is also a hacker server and the workstation (rendered active) opens a “reverse backdoor” to the hacker server; and,
in FIG. 7e, the assailant is an altered network through which a session passes, thus disclosing information of the workstation.

Of course, the examples above are illustrative and in no way limiting.

Returning to FIG. 6, the attack specified in step 61 is launched in a step 62. In a step 63, it is executed by the attacks/parries engine. And in a last step 64, the result of the attack is noted. Steps 61 to 64 are iterated, being executed for each attack of the scenario of attacks.

The result of an attack, if it succeeds, is to cause one of the ACID states of the target component to pass to a degraded value (unsound), or to a more serious degraded value if it was already at a degraded value. For example in the case of the “block” attack:
if the component is less degraded than “blocked” (for example, “saturated”), then it becomes “blocked”;
if it is already “blocked”, then it remains “blocked”; and,
if it is more degraded than “blocked” (for example “destroyed”), then it does not change state.

The manner of operation of the attacks/parries engine will now be described in greater detail. Typically, the transmission of an attack over the attack path is effected according to three successive phases, illustrated by the diagram of FIG. 8, namely:
a propagation phase during which the attack traverses the vector components, which may or may not provide the security filtering via their protection rules;
an absorption phase during which the attack may or may not degrade the target, depending on its own defenses (protection rules); and,
a contagion phase during which the degradation of the target may be communicated to other components without them being able to defend themselves (for example, the explosion of an office brings about the destruction of the equipment present in this office).

When an attack arrives in a component, the attacks/parries engine performs therefor a certain number of checks (rules), based on the states of certain components, and in particular on the components situated upstream and downstream in the path of the attack. For these latter components, represented in the diagram of FIG. 9, the information available to the attacks/parries engine is consigned respectively to the upstream stack and to the downstream stack which were presented earlier with regard to the diagram of FIG. 2. These upstream and downstream stacks are the modeling of the indications borne on the real objects (for example addresses and postmarks on a parcel, IP addresses on an IP packet, etc.).

The upstream stack gives the list (in order) of all the components already traversed by the attack. In an example, there are precisely two upstream stacks: the one which contains the exhaustive list of all the components, together with their real name, and the other which contains only the list of opaque components, together with their alleged name. The first list is used to execute the component's possibility and contagion rules. The other is used to execute in respect of the protection rules (identification, authorization and routing).

The downstream stack gives the list of identified destinations of the attack. There is a final destination, and possibly one or more intermediate destinations. These intermediate destinations are specified, either by the user during the definition of an attack, or by the functional routing. The downstream stack is used by the rules of the components.

In the example illustrated in FIG. 10, the router 111 and the Internet 112 are transparent (since the source IP address of the IP packets coming from outside is unchanged). This is why, being stacked in the first upstream stack 110 of real names, and they are not stacked in the second upstream stack 120 of visible names (that is to say real or alleged, as the case may be). Additionally, the hacker 113 usurps the name of a user 114. His “visible name” (stacked in the second upstream stack 120) is therefore “user” and not “hacker”. The downstream stack is designated by the reference 130.

For each transit of an attack, the engine performs the following three operations:
firstly, it determines the next destination component of the attack: this is the first component of the downstream stack,
secondly, it determines, by virtue of the local routing matrix, which relation is the one to be adopted to go to this component; and,
thirdly, the component which lies on the other side of the relation becomes the current component.

The attack stops when the downstream stack is empty (and not when the finish component is reached, since other components may be stacked downstream after the finish).

For the current component (reached through the attack), the engine performs the following operations, illustrated by the diagram of FIG. 11:
it extracts the current component from the downstream stack, if it is there (step 1);
it tests the component's propagation rules, which may accept or deny the attack;
if the attack is denied, the engine stops it, otherwise it continues the following actions,
within the framework of the functional routing rules, it can stack an intermediate component downstream (step 2);
it stacks the current component in the upstream stack (step 3); and
if the attack is accepted, it routes it to the next component.

The general algorithm for the operation of the attacks/parries engine is given by the chart of FIG. 12.

In this chart, the keyword “me” designates the current component. To transport or absorb an attack, the current component must be in the “open” state (state A of the ACID states). To absorb the attack, the target component must be found in the first upstream stack, that of the real names. It will be noted that the identification and authorization rules always give “yes” as a result if the component is corrupted.

In FIG. 12, the three phases of the transmission of the attack, namely propagation, absorption and contagion of the attack, are represented separately.

Step 2 of the method, which is the parametrization of the rules for protecting the components, will now be described.

When the architecture of a system is specified (at the end of step 1), this architecture being represented by the components/relations graph, then the behavior of the components still has to be described, from the operational and security standpoints.

For this purpose, step 2 consists in parametrizing the operation of each component, and in particular in describing the protections that it affords. This is done by means of the entry of rules, structured according to a language and a grammar of rules.

The rules language is characterized by, its capacity for realism (to precisely describe the manner of operation of a real component), ergonomics for the user (simplicity, flexibility, naturalness, few special signs) and genericness (that is to say the fact that it allows easy reuse of the rules from one model to the other).

From the editing standpoint, the language is preferably in the form of ASCII or XML text, is readable, modifiable and printable with a conventional text processor (such as Notepad, MS-Office), accepts natural language comments in the form: /* comment */, accepts upper case/lower case and accents (but which are not discriminating), and uses the characters “blank” and “next line” for presentation only.

Preferably, the words of the language appear in the same manner and in the same form in the graphical representation of the components/relations model, in the specification of the rules (rules language), in the specification of the attacks (attacks language), and in the journal of attacks.

The language is chiefly a predicates language (or logic-condition criteria), using logical operators (such as AND, OR, NOT), keywords (such as “attack”, “upstream”, “downstream”, “protocol”, “me”), and names of components in direct form or through an adjective, or else through a service relation.

For example, the predicate “upstream(person)=admin+attack=corrupt” signifies that the “corrupt” attack is authorized to pass into the component if upstream there is a person having the role “admin” (administrator).

An example of generic keywords, which is merely illustrative, is given by table IV hereinbelow. Additionally, these generic keywords should be supplemented with the sixteen values of the potential states and the twelve values of the attacks.

TABLE IV

| Generic | | | Usable by | |
|---|---|---|---|---|
| keyword | Designates | Meaning | Rules | Attacks |
| upstream | component | upstream (possibility and | + | |
| | | contagion rules) | | |
| upstream | component | upstream (other rules) | + | |
| | | under alleged name | | |
| downstream | component | downstream | + | |
| me | component | currently undergoing | + | |
| | | processing | | |
| entry | component | last traversed upstream (= | + | |
| | | entry relation) | | |
| start | component | first upstream | + | + |
| target | component | target of the attack | + | + |
| finish | component | finish point of the attack | + | + |
| attack | attack | type of an attack | + | + |
| protocol | protocol | type of protocol | + | + |
| intermediate | component | imposed on the path of the | | + |
| | | attack | | |
| islicit | mode | indicates whether the | | + |
| | | attack is licit or not | | |
| present | state | presence of a component in | + | |
| | | a stack | | |
| absent | State | absence of a component in | + | |
| | | a stack | | |
| authentic | state | state of a nonusurped | + | |
| | | component | | |
| usurped | state | state of a component | + | |
| | | usurped by another | | |
| usurper | component | component which usurps | + | |
| | | another one | | |

The components description language makes it possible to write rules, which each comprise a variable number of predicates (Boolean logical condition) and possibly of actions. For each component, there are eight types of rules. The rules have two independent characteristics:
they may be binary (Boolean logical conditions, giving a yes/no value) or functional (logical condition involving a routing or contagion action); and,
they may be “propagation rules” (in the attack vector components) or “absorption rules” (in the attack target components).

In an example, five propagation rules and three absorption rules are given respectively by table V and by table VI hereinbelow.

TABLE V

| rule | type | role | example |
|---|---|---|---|
| possibility | binary | defines which attacks | software cannot |
| | | may pass | transport a postal |
| | | | parcel |
| identification | binary | provides for the | an attack will be |
| upstream | | identification and | accepted if the |
| | | authentication of the | password has been |
| | | upstream components | previously divulged |
| identification | binary | provides for the | |
| downstream | | identification and | |
| | | authentication of the | |
| | | downstream components | |
| authorization | binary | defines which attacks | a firewall device |
| | | are authorized to | may preclude |
| | | pass | discovery attacks |
| | | | by “Ping” packets |
| routing | functional | defines the component | a router dispatches |
| | | to which the attacks | the mail messages |
| | | are to be directed | to the mail server |

TABLE VI

| rule | type | role | example |
|---|---|---|---|
| possibility | binary | defines which attacks | an office can |
| | | may pass | absorb a physical |
| | | | bomb, but not a |
| | | | logic bomb |
| identification | binary | provides for the | an attack will be |
| upstream | | identification and | accepted if the |
| | | possible | password has been |
| | | authentication of the | previously divulged |
| | | upstream components | |
| contagion | functional | defines which states | the explosion of an |
| | | must be propagated to | office brings about |
| | | which components | the destruction of |
| | | | the equipment |
| | | | hosted |

The rules are applied as follows. Each time an attack turns up at a (current) component, the attacks/parries engine runs the mechanism illustrated by the chart of FIG. 13.

In order for an attack to be propagated by a vector component or be absorbed by a target component, each category of binary rule must, either be empty, or comprise a rule with a positive result.

If the attack is accepted by a vector component, the latter applies the functional routing rules according to the mechanism illustrated by the chart of FIG. 14a. Likewise, if the attack is accepted by the target component, the latter applies the contagion rules according to the mechanism illustrated by the chart of FIG. 14b.

The local routing and functional mechanisms will now be described. The function of routing is to direct the attacks from one component to the other, with the aim of reaching the finish point or the intermediate points. There are two kinds of routings.

Firstly, functional routing, defined by the user via the routing rules, and which makes it possible to define a new intermediate component before reaching the finish point. This component is inserted into the downstream stack. For example, a router decides to route an email coming from outside to the messaging server.

Secondly, local routing, invisible to the user, the effect of which is to direct the attack to the next component of the downstream stack, according to the shortest path. A local routing table is used for this purpose. It is recalled that this table is constructed automatically at the end of modeling, according to the principle of searching for the shortest path. In an example, it is structured in the form of a start/finish (component) matrix.

Functional routing makes it possible to provide both for the nominal operation of the system, and certain security functions. For example, a router which dispatches the IP packets to a firewall device provides for a security function. This security function may be degraded in the case of diversion, as will now be described.

The technique of diversion, fundamental in attack scenarios, may be taken into account by the device. This technique consists in modifying the way in which the functional routing is effected. There are three kinds of diversions, illustrated by the chart of FIG. 15.

Represented in FIG. 15 is an example of a propagation path going from a client 151 to a server 155 through (in this order) a first router 152, a filter 153 and a second router 154.

A first diversion is a bypass diversion, symbolized by the arrow 156. In the example represented, the router 152 is altered so that its downstream component, the filter 153, is deleted.

A second diversion is an interception diversion, symbolized by the arrows 158a and 158b. In the example represented, the router 152 is altered so that a downstream component 157 is added into the propagation path. This downstream component is a hacker (usurper). In this case, the server 155 is said to be usurped.

A third diversion is a usurping diversion, symbolized by the arrow 150. In the example represented, the router 154 is altered so that its downstream component, the server 155, is replaced with another downstream component 159. This other downstream component is a hacker (usurper), the server 155 is said to be usurped.

A diversion may be effected by any component having a routing function, situated in the path of the attack. It is triggered by the conjunction of three conditions:
the routing component has an “altered” state (indicating that its routing tables are altered);
the finish component is “usurped” (at least in respect of usurping and interception); and,
the routing component has a (or several) particular rule which provides for diversion.

A first supplementary mechanism of the invention, consisting of the metrics of feasibility and of nondetection, will now be presented.

The aim of the metrics is to supplement the rules language, which is chiefly centered around protection by prevention. They make it possible to rank the success or the failure of the attacks, by calculating a feasibility and nondetection coefficient, thus affording protection by detection.

In an example, there are five metrics of which three are basic metrics, which are parametrized during modeling, and two are mishap probability metrics, which are calculated during simulation.

In order to avoid getting caught up in complexity, the basic metrics are evaluated on a restricted number of levels, for example four levels. This scale of levels should be understood as a logarithmic scale, that is to say each level involves a multiplier coefficient with respect to the lower level. The four levels correspond for example to the values 0.1%, 1%, 10%, 100%.

Two basic metrics relate to the viewpoint of the defender. These are: a metric of effectiveness of parries (resistance), and a metric of effectiveness of detection of attacks. These two metrics are parametrized by the user during the modeling phase, independently for each protection rule in each component, according to a scale of values such as low, average, high, absolute.

Furthermore, a basic metric relates to the viewpoint of the attacker. This is a metric of means of the attacker. This metric comprises for example the following aspects: skill, tools, money, time. It is parametrized by the user during the simulation phase, in a global manner for the attacker, all means, all attacks and all targets included together. The scale of values is for example: public, initiate, specialist, expert.

The metrics of probability of mishap are calculated by the attacks/parries engine during the passage through each component, then consolidated by the engine over the whole path, then over the whole scenario. This is a metric of probability of passage of an attack on a component, on the one hand, and a metric of probability of nondetection of an attack on a component, on the other hand. Preferably, they are expressed on the four-level scale of the basic metrics, supplemented with the 0% level, and they are calculated according to the following formulae:
probability of passage=(means of the attacker)/(effectiveness of the protection);
probability of nondetection=(means of the attacker)/(effectiveness of the detection).

Table VII hereinbelow gives the calculation of the metrics calculated.

TABLE VII

| | | | | | | |
|---|---|---|---|---|---|---|
| Effectiveness of the | 0.1% | Low | 0.1% | 1.0% | 10.0% | 100.0% |
| defender | 1.0% | Average | 0.0% | 0.1% | 1.0% | 10.0% |
| | 10.0% | High | 0.0% | 0.0% | 0.1% | 1.0% |
| | 100.0% | Absolute | 0.0% | 0.0% | 0.0% | 0.1% |

| | | | | |
|---|---|---|---|---|
| Means of the attacker [symbol] | Public | Initiate | Specialist | Expert |
| | 0.1% | 1.0% | 10.0% | 100.0% |

Another supplementary mechanism of the invention, which forms part of the man/machine interface, will now be described.

Advantageously, the man/machine interface exhibits a so-called “multiview” functionality. This is not in itself original, since most software uses this sort of functionality. What is original, on the other hand, is the use of views to aid the user to control complex systems, by virtue of an association between the (software) views and the (conceptual) subsystems.

The system of “views” is an important element of the man/machine interface, which allows the modeling of complex systems. Its principle is to decompose the system into several views, one of which alone is displayed on the screen in the main window, the user being able to pass alternately from one view to the other. Any component may be placed in a view, in another, or in several views, as the user chooses.

The diagram of FIG. 16 shows an exemplary graphical representation of a (modeled) system according to three overlaid views. The wavy line symbolizes an attack path passing through the three views.

There are no constraints in respect of the definition of the views, and in respect of the distributing of the components into the various views of a system. It is for example possible to put in place views associated with the various jobs of the system (geographical, computing, organizational).

Advantageously, with the help of certain simple principles, taken in isolation or in combination, the views nevertheless become an element of functional structuring of the systems.

According to a first such principle, each view preferably represents a subsystem that is relatively autonomous and independent of the remainder of the system.

According to a second such principle, matters are preferably contrived such that there are no propagation relations nor service relations between two views. Only the common components shared by two views provide for the function of interconnection between the views.

According to a third such principle, finally, the rules of the components situated in a view should not call by name upon components situated in another view.

More generally, there are two ways of designing the views. Either the views are considered to be mutually interconnected subsystems of like level (for example, sites interconnected via the Internet, the common component being the Internet). Or else one of the views is considered to be a global description of the system, while the others represent details of this or that complex component. This approach is called the hierarchical approach and will now be detailed.

The hierarchical approach is very powerful, since it makes it possible to assemble detailed components fine-tuned previously to form very complex and realistic systems by assemblage, while remaining simple to visualize.

In this approach, illustrated in the form of an example given in FIG. 17, a higher view presents the global system, which contains one or more components each representing a subsystem. Each lower view gives the detail of a subsystem. In the figure, the wavy line symbolizes an attack path passing through both views.

A component A common to the higher view and to a lower view, called a “relay component”, represents the subsystem seen from the global system, and vice versa. The relay component is the only interface between the two views.

The relay component provides for the leaktightness between the views, while providing for communication between them, according to a triple role.

The relay component provides firstly for a routing relay role. Specifically, it provides for the routing of the attacks in both directions between the two views. For this purpose it uses all the routing criteria available in the rules language.

The relay component then provides for a service relay role. Specifically, it can have service relations, starting or ending, in the two views. This makes it possible to designate a component from one view to another via indexation.

The relay component finally provides for a state contagion relay role. For this purpose, in respect of the higher view it provides for a synthetic picture of the lower view, via a contagion of the main states representative of this view.

In FIG. 18, in which the same elements as in FIGS. 1 and 2 bear the same references, is represented the schematic diagram of an exemplary embodiment of a device according to the invention. This device is appropriate for the implementation of the method according to the invention.

In this example, the device is installed in a general usage computer comprising a microprocessor 10. The man/machine interface 15 and the attacks/parries engine 16 are implemented in the form of software modules, saved in a memory 17 and more particularly in a read only memory (ROM). They are executed by the microprocessor 10 when they are loaded into the random access memory of the computer.

To provide for the input of data values by the user, the device comprises a keyboard 19b, and in general also a mouse (not represented) or the like. For the displaying of the data, in particular the displaying of the graphical representation of the system modeled in the form of one or more views, the device also comprises a screen. These elements are those which equip the computer.

Finally, the device comprises a random access memory 18, in particular a RAM memory, in which the files 11, 12, 13 or 14 may be saved.

1-44. (canceled)

45. A method for analyzing the security of an information system comprising:
a modelling phase, comprising on the one hand the specification of the architecture of the information system with a graphical representation of a set of components of the system and relations between said components, each component being associated with at least one state initialized with a sound value, the relations between two determined components comprising propagation relations able to convey attacks, and on the other hand the specification of a set of behavioural rules, from the standpoint of the operation of the system and from the standpoint of security, associated with the components of the system, each behavioural rule comprising one or more predicates and/or one or more actions; and,
a simulation phase, comprising the specification and the simulation of potential attacks against the information system, a successful attack causing a state of a component to pass to an unsound value.

46. The method of claim 45, wherein, a name being associated with each component, one or more adjectives may also be associated with said component, which adjectives make it possible to designate said component without naming it.

47. The method of claim 45, wherein determined states are associated with each component of the information system, each state being able to take a sound value and one or more unsound values.

48. The method of claim 47, wherein certain at least of said states pertain respectively to the activity, the confidentiality, the integrity and/or the availability of the component with which they are associated.

49. The method of claim 45, wherein an alleged name may be associated with any determined component, in particular in the case where said determined component is a usurper.

50. The method of claim 45, wherein a link to another component may be associated with any determined component, in particular in the case where said determined component is usurped and where said other component is a usurper.

51. The method of claim 45, wherein the propagation relations are bidirectional relations able to convey attacks in both directions.

52. The method of claim 45, wherein the relations between any two determined components comprise service relations making it possible to designate a component on the basis of another component.

53. The method of claim 45, wherein the behavioural rules comprise rules for propagating attacks, these rules being for example implemented in components which are vectors of attacks, and rules for absorbing attacks, these rules being for example implemented in components which are the target of attacks.

54. The method of claim 45, wherein the behavioural rules comprise binary rules, for example Boolean logic conditions giving a value of type yes/no, and/or functional rules, for example logic conditions involving a routing action (for a propagation rule) or contagion action (for an absorption rule).

55. The method of claim 45 comprising, at the end of the modelling phase, the construction of a local routing table, making it possible to direct an attack from a start component to a finish component.

56. The method of claim 55, wherein the local routing table is generated automatically according to the principle of the shortest path between the start component and the finish component.

57. The method of claim 56, wherein the attacks simulation step comprises the updating of the state of a component of the system altered by a successful attack.

58. The method of claim 57, wherein the simulation phase furthermore comprises the building of a file or journal of the attacks, containing the log of the changes of the state of the components consequent upon successful attacks, in particular to allow subsequent processing by a user.

59. The method of claim 57, wherein the attacks comprise elementary attacks corresponding to unsound state values.

60. The method of claim 57, wherein the attacks further comprise a special usurping attack.

61. The method of claim 57, wherein an attack is defined, in particular, by a type of attack, a type of protocol, and attack path elements.

62. The method of claim 61, wherein the attack path elements comprise a start component, a finish component, a target component, and as appropriate one or more intermediate components.

63. The method of claim 61, wherein the list of components already traversed by an attack is saved in one or more upstream stacks.

64. The method of claim 63, wherein the upstream stacks comprise a stack containing the exhaustive list of all the components traversed, designated by their real name.

65. The method of claim 63, wherein the upstream stacks comprise a stack containing the list of only those components traversed which are opaque, designated by their real name or, as appropriate, by their alleged name.

66. The method of claim 61, wherein the list of destination components of an attack is saved in at least one downstream stack.

67. The method of claim 61, wherein the attacks are defined in a language using the same words as a language in which the behavioural rules are defined.

68. The method of claim 61, wherein the modelling phase and/or the simulation phase are implemented by a user by means of a man/machine interface comprising a multiview functionality, wherein a graphical representation of the system is presented to the user as several views.

69. The method of claim 68, wherein each view represents a subsystem of the system, which is relatively autonomous and independent of the remainder of the system.

70. The method of claim 68, wherein the function of interconnection between the components included in two distinct views is ensured only via the common component or the common components shared by the two views.

71. The method of claim 68, wherein the behavioural rules for the components belonging to a view do not call by name upon components belonging to another view.

72. The method of claim 68, wherein the views are associated with respective subsystems, for example of like level, which are interconnected together via at least one common component.

73. The method of claim 68, wherein a higher view is associated with the system as a whole, whereas one or more lower views are respectively associated with a determined subsystem of the system.

74. The method of claim 73, wherein a determined component, common to the higher view and to a determined lower view, represents the corresponding subsystem viewed from the system as a whole, and vice versa.

75. The method of claim 74, wherein said common component is the sole interface between the higher view and said determined lower view.

76. The method of claim 74, wherein the modelling phase further comprises the specification of one or more basic metrics associated respectively with the components.

77. The method of claim 76, wherein the basic metrics comprise a metric of effectiveness of parries, a metric of effectiveness of detection of attacks, and/or a metric of the means of an attacker.

78. The method of claim 76, wherein the simulation phase comprises the calculation of one or more metrics of probability of mishap.

79. The method of claim 78, wherein the metrics of probability of mishap comprise a metric of probability of passage of an attack on a component.

80. The method of claim 78, wherein the metric of probability of passage of an attack on a component is calculated according to the formula “probability of passage=(means of the attacker)/(effectiveness of the protection)”.

81. The method of claim 78, wherein the metrics of probability of mishap comprise a metric of probability of nondetection of an attack on a component.

82. The method of claims 81, wherein the metric of probability of nondetection of an attack on a component is calculated according to the formula “probability of nondetection=(means of the attacker)/(effectiveness of the detection)”.

83. A device for the implementation of a method for analyzing the security of an information system, said device comprising:
a man/machine interface for the implementation of a modelling phase comprising a modelling phase, comprising on the one hand the specification of the architecture of the information system with a graphical representation of a set of components of the system and relations between said components, each component being associated with at least one state initialized with a sound value, the relations between two determined components comprising propagation relations able to convey attacks, and on the other hand the specification of a set of behavioural rules, from the standpoint of the operation of the system and from the standpoint of security, associated with the components of the system, each behavioural rule comprising one or more predicates and/or one or more actions; and,
an attacks/parries engine for a implementation of a simulation phase comprising the specification and the simulation of potential attacks against the information system, a successful attack causing a state of a component to pass to an unsound value.

84. The device of claim 83, wherein the man/machine interface has a functionality of multiview display of the system modelled.

85. The device of claim 83, wherein the man/machine interface is configured to display the system modelled according to a components/relations model.
